(19) United States
(12) Patent Application Publication
(10) Pub. No.: US 2010/0024215 A1
(43) Pub. Date: Feb. 4, 2010

(54) Jig for manufacturing components of aerodynes and wing turbines and manufacturing process for these components

(76) Inventor: Manuel Torres Martinez, Pamplona (Navarra) (ES)

Correspondence Address: THE NATH LAW GROUP, 112 South West Street, Alexandria, VA, 22314, US

(21) Appl. No.: 12/457,884

(22) Filed: Jun. 24, 2009

(30) Foreign Application Priority Data
Jul. 31, 2008 (ES) P 2008 02276

(51) Int. Cl. B23P 15/02; B25B 27/14

(52) U.S. Cl. 29/889.7; 29/281.1

(57) ABSTRACT

The invention relates to a jig for manufacturing components of aerodynes and wind turbines and a manufacturing process for these components, the jig comprising a base (10), on which at least one rigid part (7) like a flange is arranged in the upper edge of at least one of the sides, which rigid part is connected to the base (10) through an elastic hinge (8), which can driven to pivot between a raised closed position and a lowered open position, for the molding and demolding of the components to be manufactured by means of incorporating fiber strip layers on the surface that they determine between the base (10) and the flange or flanges (7).

### STATE OF THE ART

Composite materials, formed by two or more materials and based on the use of carbon fibers, glass fibers, etc., provide a series of advantages including that of providing a high strength with minimum weight, therefore they are increasingly used in different industrial sectors, such as the aeronautical sector, shipbuilding sector, renewable energy sector, civil construction sector, etc.

In the aeronautical sector, such composite materials are used to form the aerodynamic profiles of the wings and the stabilizers of aerodynes; whereas in the renewable energy sector, such composite materials are used to manufacture the blades, hubs, shafts and towers of wind turbines, all of this as the most common but non-limiting applications.

### OBJECT OF THE INVENTION

The object of the present invention is especially designed for its application in the manufacture of components of aerodynes and wind turbines, but this must be understood in a limiting sense either, since as it will be seen below, both the jig and the manufacturing process object of the present invention are valid for forming large structures of composite materials which can be used in any sector.

Indeed, in order to be able to manufacture large structures in composite materials, formed based on fibers and resins, it is necessary to develop new structural concepts, new equipment goods, tools, molds and manufacturing processes simultaneously and with concurrent engineering, as the only way to ensure the repetitiveness in the entire production process and the homogeneity thereof, thus ensuring obtaining products with a suitable and uniform quality at competitive prices.

Focusing on the manufacture of the aerodynamic profiles of the wings and of the stabilizers of aerodynes and on the manufacture of the blades of the wind turbines, an implementation thereof is already known which is essentially based on a torsion box formed by one or more spars, connected to the lower surface, to the upper surface and to the leading edge of the wing profile.

The previously mentioned spars are fundamentally based on a U-shaped configuration changing in height in the different longitudinal sections of said spars, while at the same time they have variations of the angles forming the profile; all of which, added to the torsion effects that these spars must withstand due to their own shape, translates into certain complexities in the design and in the manufacture thereof.

According to the present invention, a jig for manufacturing this type of component, as well as a manufacturing process by means of using said jig is proposed, all of which allows simplifying the manufacture of these components, allowing the automation and the demolding of aerodynamic components with a complex geometry according to repetitive manufacturing processes which allow achieving suitable and constant quality conditions in the finally obtained product.

To that end, the invention proposes a jig having collapsible parts through elastic hinging means; the position of which parts can be regulated by means of positioning actuators, which provides the jig with a flexible character allowing the automation of the manufacturing process and the demolding of aerodynamic components with a complex geometry. These elastic hinging means are furthermore determined by an elastomeric material providing this area with suitable tightness condition so that a vacuum can be performed during the manufacturing process and the corresponding resin can be injected without leakages, and all of this with a surface continuity allowing the correct arrangement on these hinging means of the part located thereon of the fiber strips which must form the component to be manufactured.

Likewise and according to the present invention, a manufacturing process by means of using said flexible jig is proposed, which allows manufacturing complex structures both through automatic and manual processes.

### DESCRIPTION OF THE DRAWINGS

FIG. 1 shows a schematic perspective view of a blade of a wind turbine.

FIG. 1A is a perspective exploded view of the essential components of the wind turbine blade depicted in FIG. 1.

FIG. 2 shows a cross-section of a blade of a wind turbine, formed by two spars (4), two skins (3) and the leading edge (1), all of this according to a non-limiting practical embodiment in which the spars (4) and the skins (3) present a sandwich implementation to prevent their bulging.

FIG. 3 shows a perspective view of a spar (4).

FIGS. 4, 5 and 6 correspond to cross-sections of the spar (4) identified respectively as IV-IV, V-V and VI-VI in FIG. 3, to be able to observe the degree of torsion and the variation of the angles of the flaps (4.1) and (4.2) of the spar (4).

FIG. 7 is a perspective view showing, according to a non-limiting practical embodiment, the implementation of the flexible jig object of the present invention.

FIG. 8 shows a cross-section of FIG. 7.

FIG. 8A shows in an enlarged manner the detail indicated in FIG. 8, to be able to see how elastic hinges (8) are determined by means of an elastomer (8.1).

FIGS. 9 and 10 are views like the previous FIGS. 7 and 8, with a first fiber layer (11) in the form of strips which can be deposited manually or preferably automatically.

FIGS. 11 and 12 are figures like the previous FIGS. 9 and 10, but now with all the fiber layers (11.1) deposited on the jig.

FIGS. 13 and 14 are figures like the previous FIGS. 11 and 12, but showing the phase of the process in which the fiber layers (12) are covered with a plastic blanket (13) which allows performing a vacuum to compact the fabric and then inject the resin on the fibers of the fabric.

FIG. 14A shows in an enlarged manner the detail indicated in FIG. 14, to be able to see the self-adhesive band (12) which allows tightly fixing the blanket (13) on the jig.

FIGS. 15 and 16 are views like the previous FIGS. 13 and 14, but now showing the flanges (7) of the flexible jig in the raised position, configuring the suitable geometry to start the curing or polymerization of the resin.

FIGS. 17 and 18 are a perspective and cross-sectional view of the flexible jig, corresponding to the phase in which the flanges (7) occupy a lowered or open position, with the spar (4) after the polymerization has already passed and ready to start the demolding.

FIGS. 19 and 20 are views like the previous FIGS. 17 and 18 but showing the phase of demolding the spar (4) which has depicted being removed from the flexible jig.

### DETAILED DESCRIPTION OF THE INVENTION

The present invention relates to a jig designed for manufacturing components, preferably of aerodynes and wind turbines, and to the actual manufacturing process for such components, which is developed by means of using said jig.

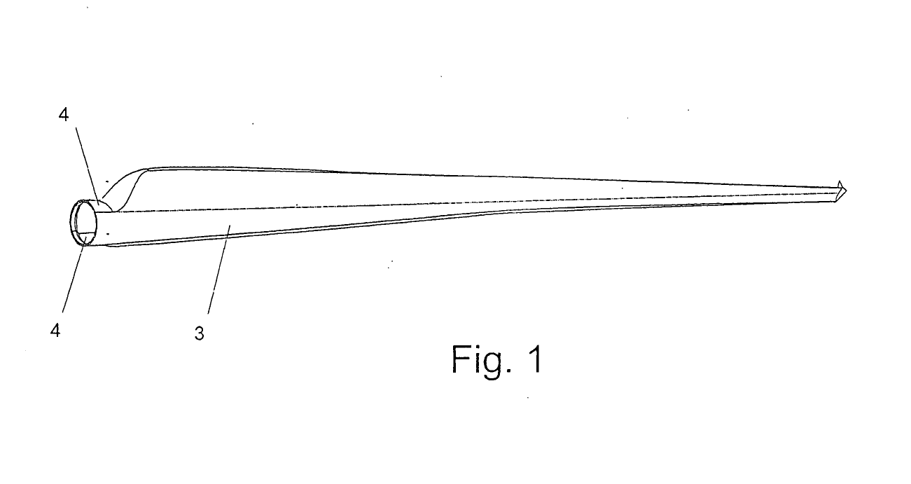

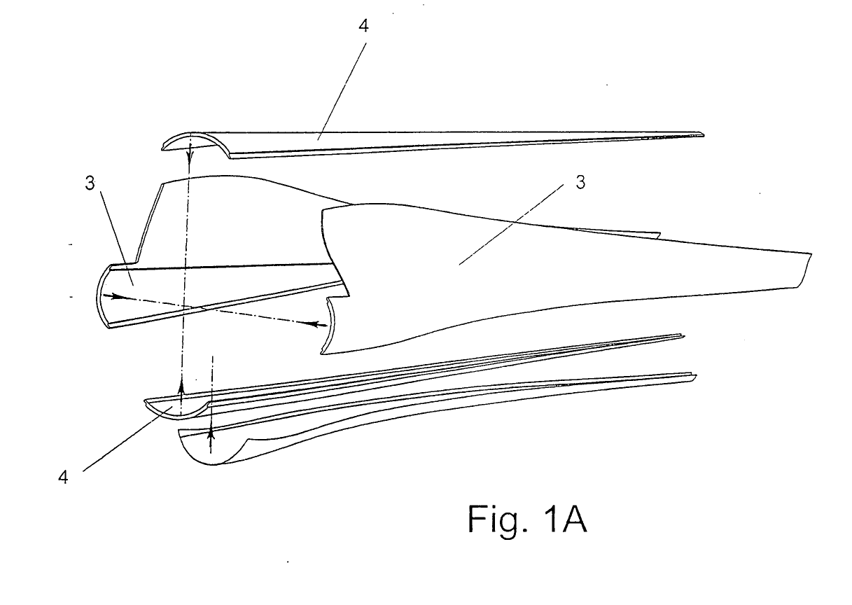

FIG. 1 shows, according to a possible non-limiting practical embodiment, the blade of a wind turbine as a possible non-limiting example of components of aerodynes and wind turbines.

In the case of the wings and of the stabilizers of airplanes, in their root, the torsion box is parallelepiped and allows the connection on the central box of the airplane fuselage. In the case of the blades of wind turbines, as can be seen in FIGS. 1 and 1A, the root of the blades is cylindrical, allowing a connection on the circular bearing of the pitch of the wind turbine.

There are different methods and ways for manufacturing these blades about which the applicant has various patents. According to the example depicted in FIGS. 1 and 1A, the cylindrical root allowing the connecting on the corresponding bearing is determined in four sectors of approximately 90° each, two of which are determined by the root of two spars (4) and the other two of which are determined by two parts (3) called skins.

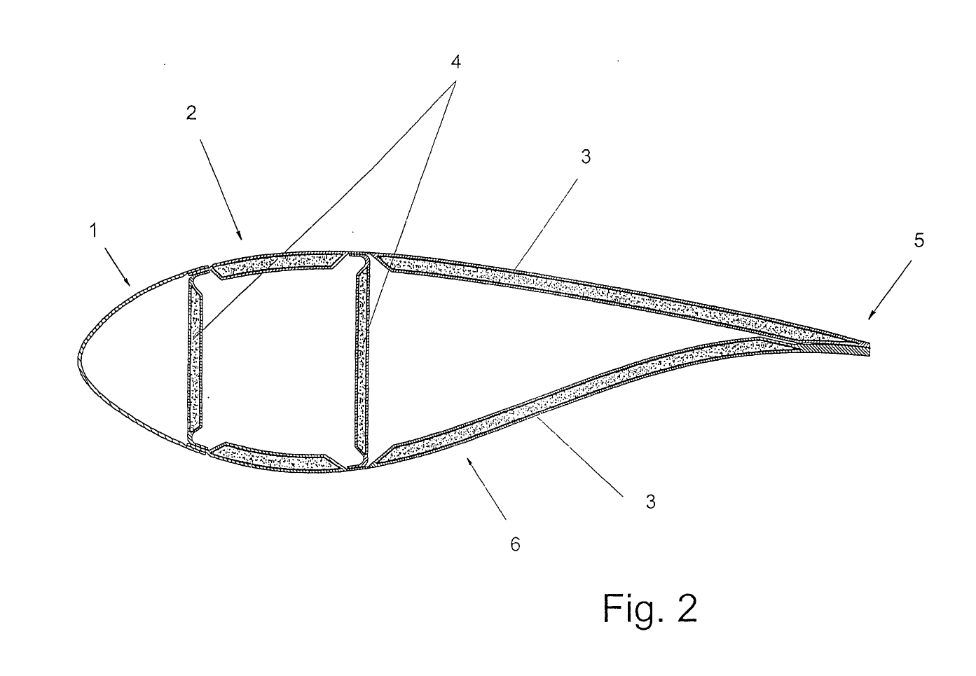

FIG. 2 shows, according to a possible practical embodiment, the cross-section of the blade of a wind turbine, wherein reference number (1) indicates the leading edge, reference number (2) indicates the area identified as upper surface and which is formed in this case by one of the two skins (3). Reference number (5) identifies the trailing edge; reference number (6) identifies the part which is called lower surface, which in this case is identified by the other skin (3), and reference number (4) identifies the two spars (4). Both the spars (4) and the skins (3) offer a sandwich implementation to prevent bulging.

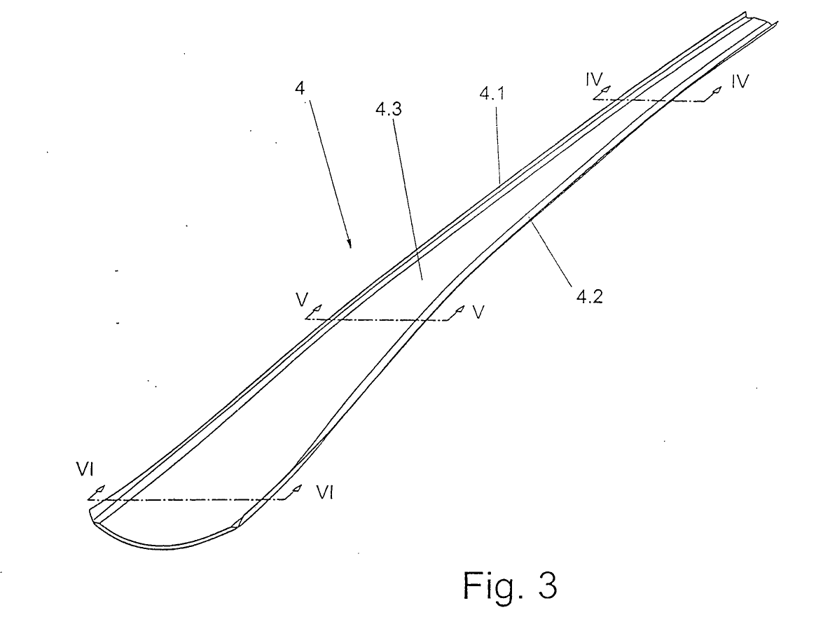

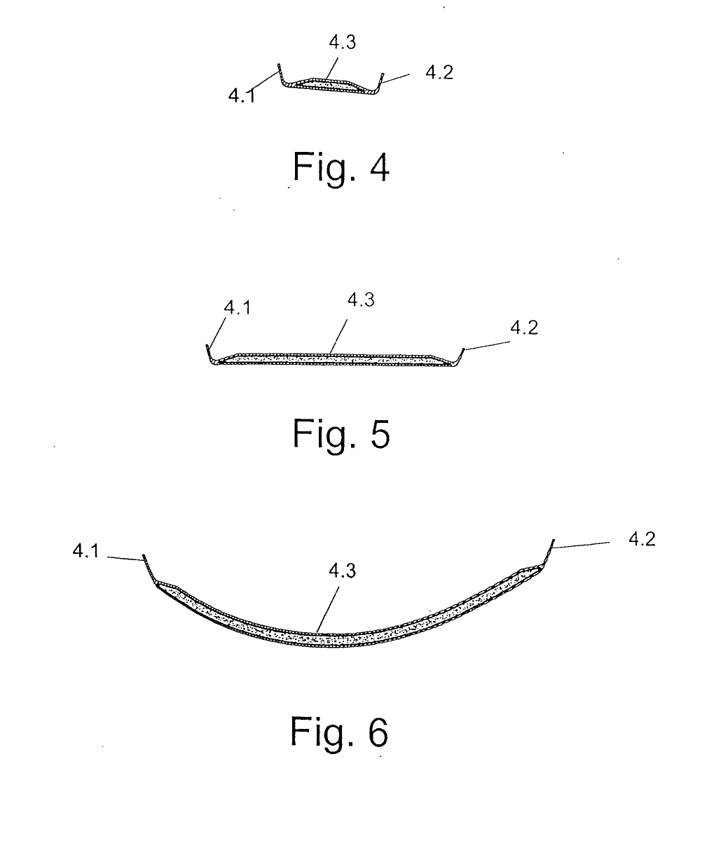

FIG. 3 shows a general perspective view of one of the two spars (4); whereas FIGS. 4, 5 and 6 show three cross-sections thereof given at different points to be able to see that each spar is formed by a central part or core identified with reference number (4.3) and along the entire edges of this central part (4.3), respective flaps (4.1) and (4.2).

In these sections of FIGS. 4, 5 and 6, it is seen how the angle formed by the flaps (4.1) and (4.2) varies, being able to be slightly greater or less than 90°. This variation of angles, together with the actual torsion and curvature of the spars (4), makes it extremely difficult to design the molds in which such spars (4) must be manufactured; such that these difficulties in the design of the molds prevents advancing towards automatic processes for manufacturing and demolding the spars (4) and generally any component of an aerodyne, wind turbine or the like, provided that it has a shape defined by a structure of large dimensions and complex forms.

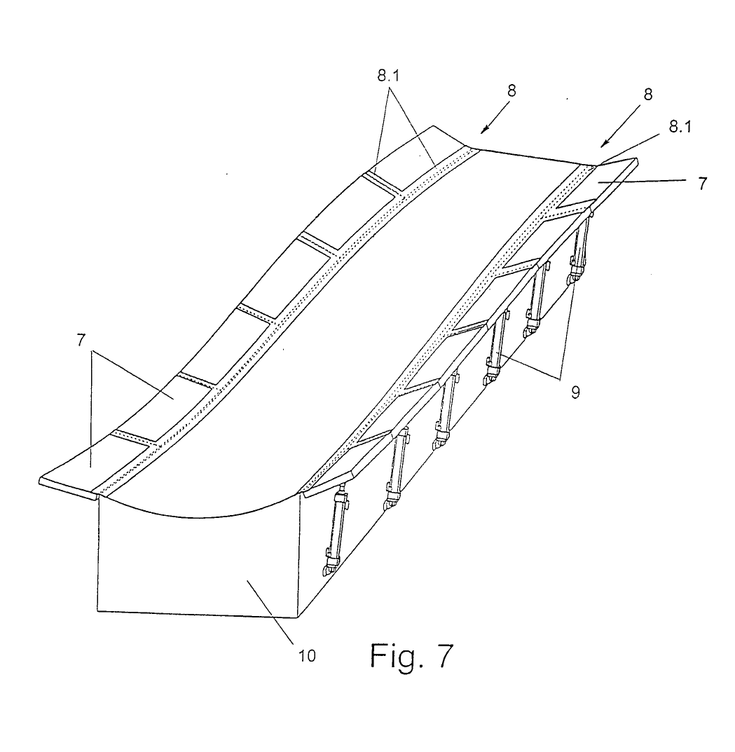

According to the present invention, a jig is proposed which has been depicted in FIGS. 7 and (8) according to a non-limiting practical embodiment. The jig is made up of a base (10) on the upper part of which the fiber strips which must form the component to be manufactured, which in this case would be a spar (4), must be deposited manually or automatically. Actuating means are coupled to base (10), which means are identified with reference number (9) and are formed, according to a possible non-limiting practical embodiment, by cylinders, the body of which is connected in an articulated manner to the base (10); whereas the end of the plunger or piston thereof is connected, also in an articulated manner, to the lower part of a part (7), of an assembly of parts (7), arranged like mobile flanges, one next to the other, following a correlation along the two sides of the base (10). These flanges (7) are made of a rigid material of metal, plastic, composite-type composite materials or any other similar material offering the suitable rigidity to be able to determine, together with the upper part of the base (10), the space in which the component to be manufactured will be molded.

According to a preferred embodiment, there will be one actuator (9) for every flange (7); such that the position of each flange (7) can be independently adjusted with respect to the positions of the rest, but two or more flanges (7) sharing a common actuator (9) would not alter the essence of the invention at all.

The various flanges (7) have also been depicted with a configuration like a narrow plate with a rectangular base and all of them basically identical in their configuration and measurements, but without altering the essence of the invention at all, the flanges (7) can have forms different from that of a plate with a rectangular base and have different forms and/or measurements from one another. It has been provided that even each flange (7), instead of being a single part, is determined by the association of several elements, such as an assembly of rigid ribs like a ribcage, all of them moved by a common actuator (9).

The connection between the flanges (7) and the base (10) is carried out by elastic hinging means (8), which allows the correlation of flanges (7) to follow the mixtilinear path of the upper edge of the base (10), as well as the possibility of moving these flanges (7) during the opening process for the demolding and withstanding the torsion stresses.

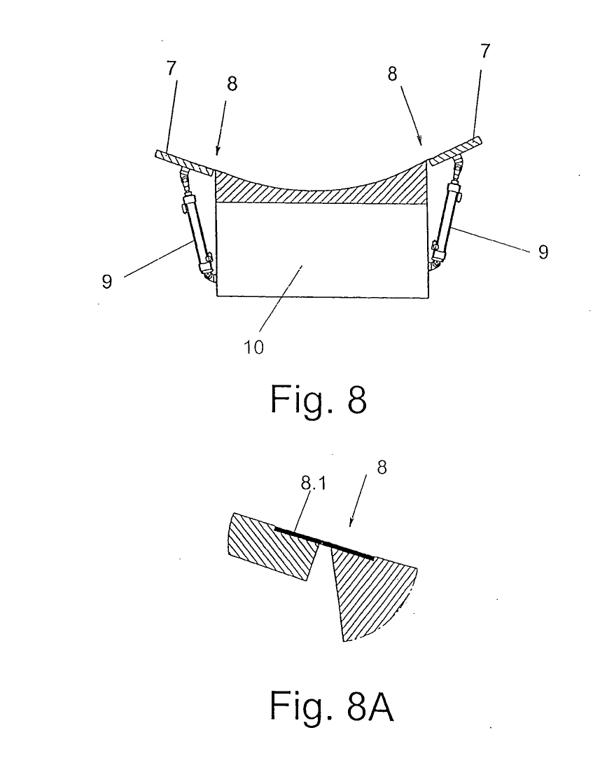

According to a possible practical embodiment of such elastic hinging means (8), as can be seen in FIGS. 7, 8 and 8A, such means are formed by an elastomer (8.1), such as a silicone, capable of withstanding the temperatures occurring during the curing of the resin. This elastomer (8.1) can thus be extended continuously along the corresponding edges of the base (10) and be extended between the different flanges (7) or even under them. The flanges (7) can be both adhered to the actual elastomer (8.1) and embedded therein. In the latter case, it may occur that the flanges (7) are completely integrated inside the elastomer (8.1) or even that the assembly of flanges (7) and elastomer (8.1) are determined by a single part made of two materials.

With this arrangement it is achieved, in the first place, that the flanges (7) can be extended along the base (10) following curvilinear or mixtilinear paths. Furthermore, it is also achieved that the flanges (7) can adopt an open or collapsed position in which the fibers are arranged on the upper part of the base (10), in order to subsequently pass said flanges (7) to a raised position, in which the corresponding curing process occurs, and to again end up collapsing them to carry out the corresponding demolding.

In addition and as can be seen in FIGS. 7, 8 and 8A, this determination of the hinges (8) by an elastomer allows defining a surface without a solution of continuity with respect to the top surface of the base (10), to be able to deposit on the fiber strips which must form the component to be manufactured on the hinges (8) without any deformation of such strips. This embodiment of the hinges (8), by means of an elastomer (8.1) furthermore allows, on one hand, obtaining a tightness in this part to be able to perform a necessary vacuum, as will be seen later, during the manufacturing process and, on the other hand, preventing leakages of the resin when it is injected during said process.

It has been provided that, according to a preferred embodiment, the different actuators (9) of the flanges (7) are controlled through a software which, automatically and upon entering the data of the component to be manufactured, determines the time and the degree of actuation of each actuator (9).

A manufacturing process for this type of component can be carried out by means of using the jig object of the present invention, the basic steps of which process are:

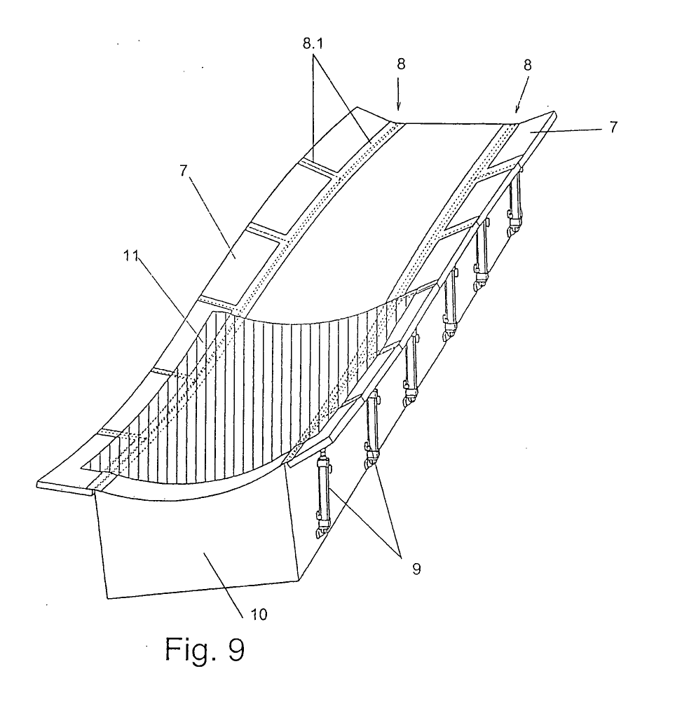

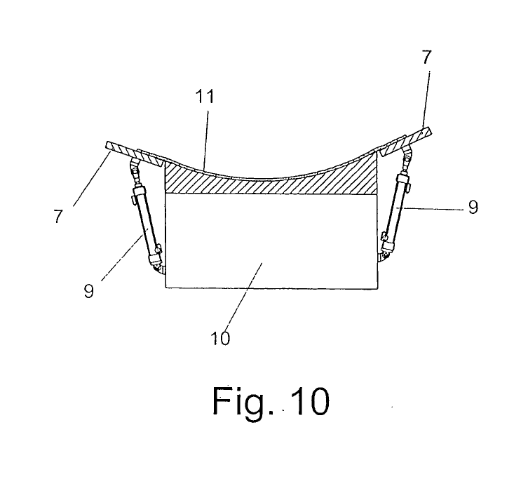

Firstly and as can be seen in FIGS. 9 and 10, with the flanges (7) arranged in the lowered or open position, a first fiber layer in the form of strips (11) is arranged on the upper part of the base (10), these strips (11) being able to be deposited manually or preferably automatically. It must be indicated that the determination of the elastic hinges (8) by the elastomer (8.1) allows achieving a completely uniform and continuous surface, so as to be able to place the strips (11) without wrinkles or deformations occurring.

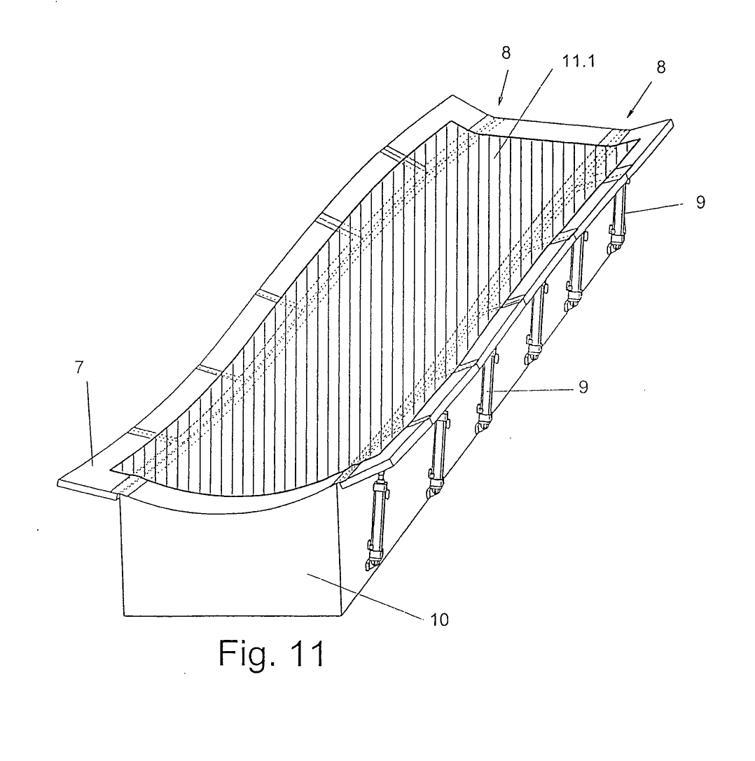

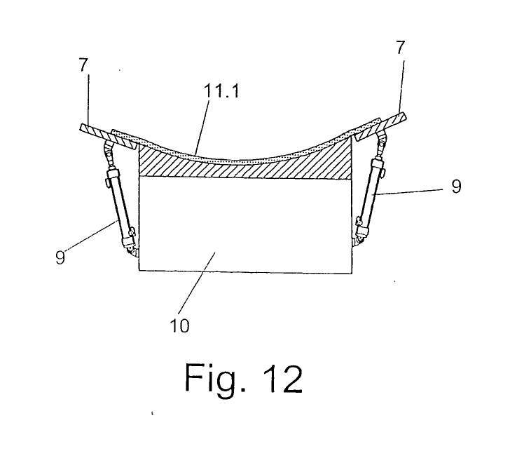

FIGS. 11 and 12 show how the corresponding stack of fiber strips (11.1) has already been deposited on the upper part of the base (10), orienting the direction of the fibers in different angles and thickness according to the loads that the spar (4) must withstand in each of its sections. The fabrics can be dry or pre-impregnated. Each band or fabric can be connected, between the different layers, in a chemical-mechanical manner, by means of using an adhesive spray, for example.

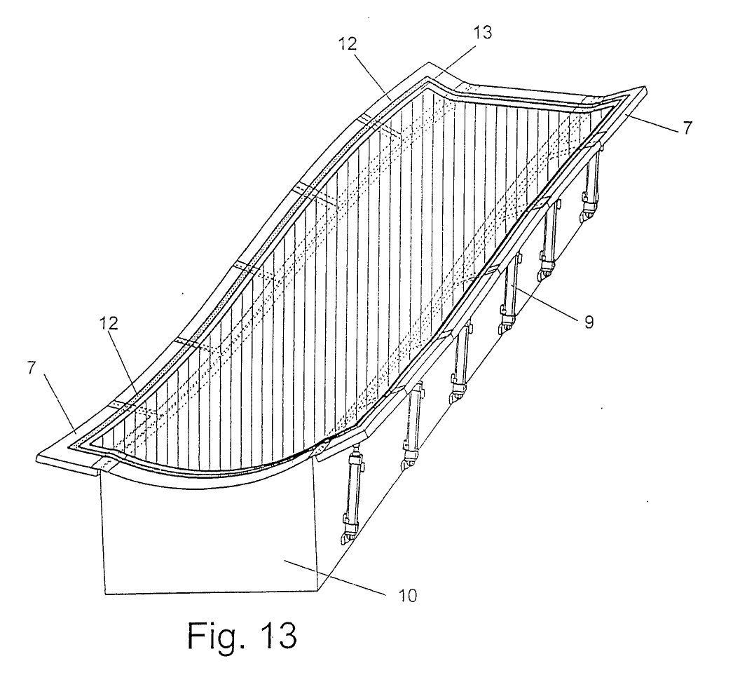

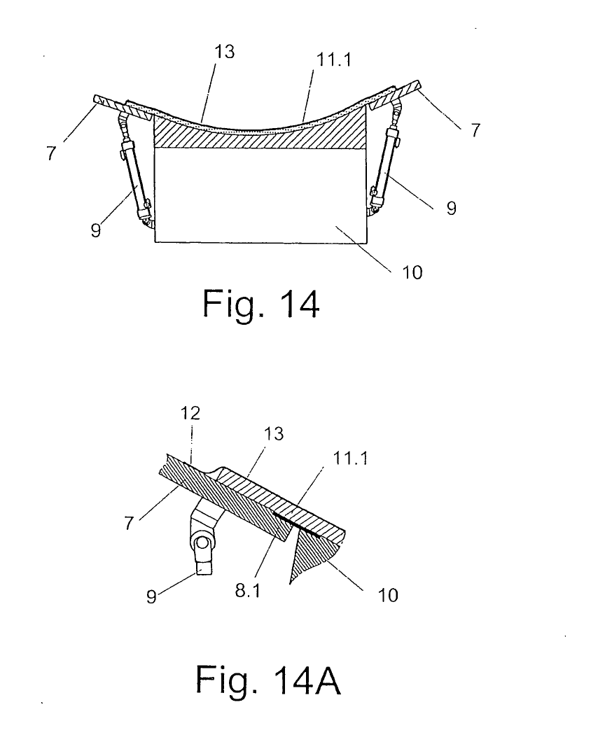

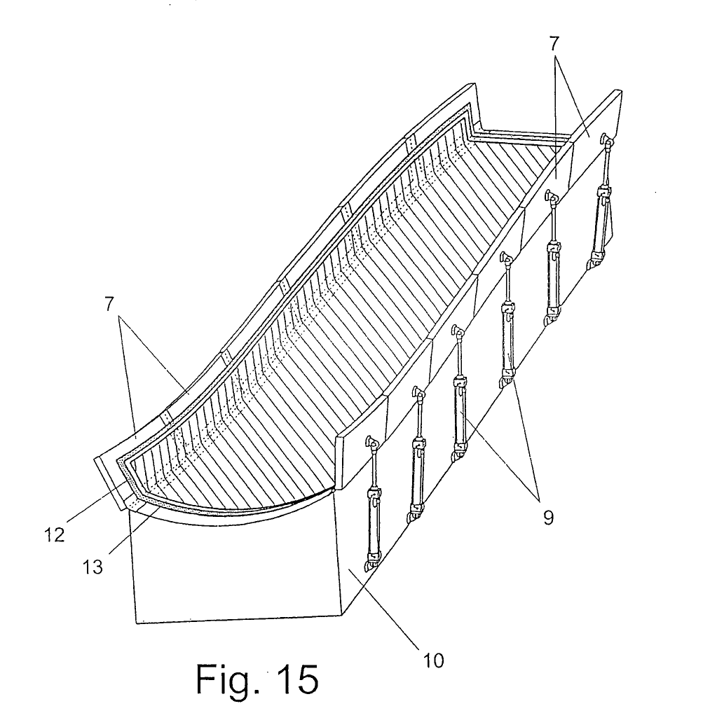

Once all the layers (11.1) have been deposited on the upper part of the base (10), the phase depicted in FIGS. 13 and 14 is carried out, according to which the fabric is covered by means of a plastic blanket (13), which allows performing a vacuum to compact the fabric and then inject the consequent resin on the fibers of said fabric. The detail of FIG. 14A shows how the plastic blanket (13) adheres on the flanges (7) through a band of self-adhesive material (12). The necessary tightness to obtain the mentioned degree of vacuum is thus achieved. It must be indicated that the determination of the elastic hinges (8) by the elastomer (8.1) allows obtaining the necessary tightness to achieve said vacuum and furthermore prevent the leakage of the injected resin.

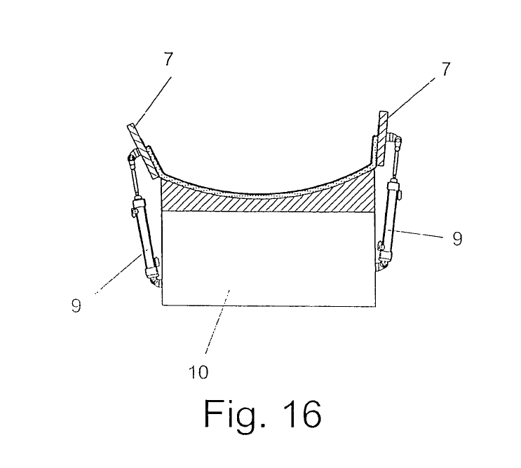

In a following phase, depicted in FIGS. 15 and 16, the flanges (7) are raised or closed by means of the drive of the actuating means (9), thus obtaining the necessary configuration of the morphology of the jig which is ready to start the curing of the resin.

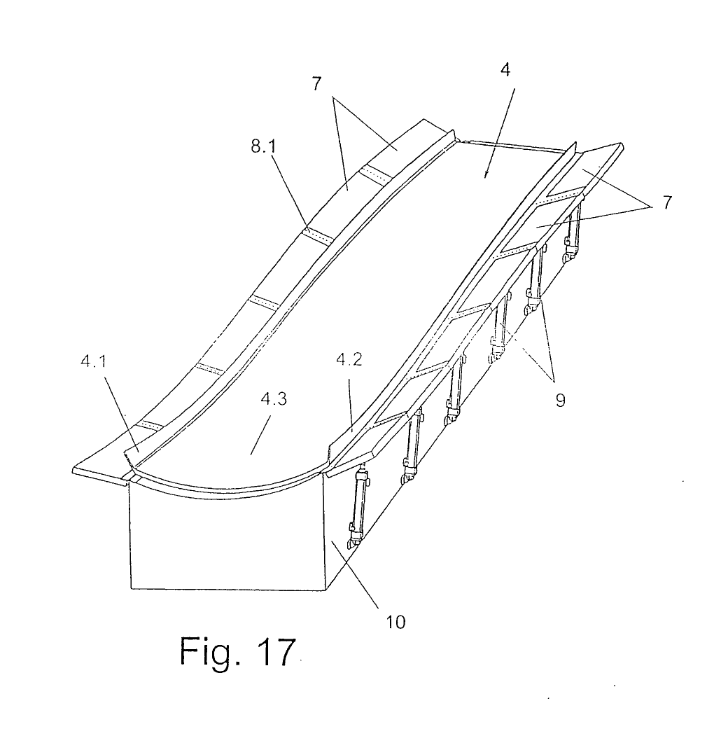

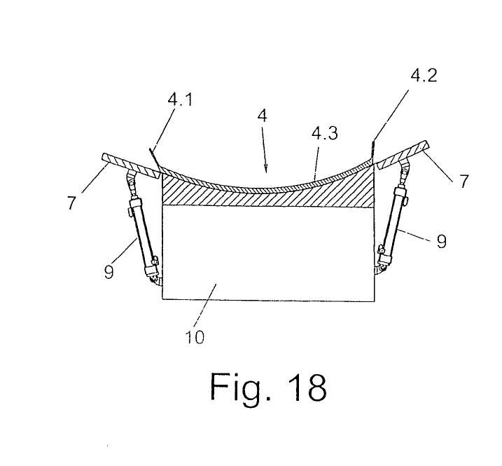

FIGS. 17 and 18 show how the spar (4) is already polymerized, its flaps (4.1) and (4.2) having the required arrangement and inclination and the flanges (7) already having been removed, which flanges return to the lowered or open position, allowing a perfect demolding of the spar (4).

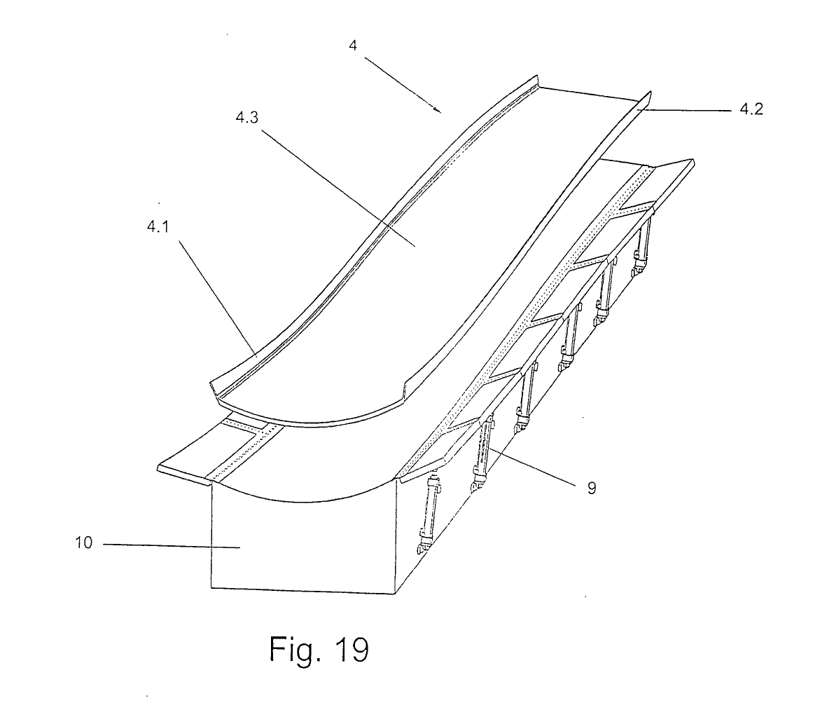

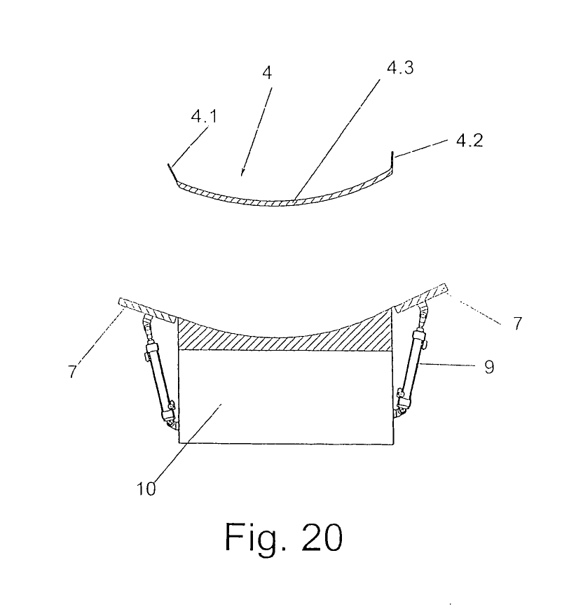

Finally, the spar (4) is demolded, as has been depicted in FIGS. 19 and 20.

1. A jig for manufacturing components of aerodynes and wind turbines, of the type which are made up of a base on the top surface of which the fiber strips which must form the component to be manufactured are arranged manually or automatically, characterized in that, in relation to the upper edge of at least one of the sides of the base (10), there is located one or several rigid parts (7), like flanges, which are connected to the base (10) through an elastic hinge (8), the elastic hinge (8) having a tight character, while at the same time it defines a surface without a solution of continuity from the upper part of the base (10) and the flange or flanges (7); and in that the flange or flanges (7) can pivot by means of the elastic hinge (8) by the drive of actuating means (9), to thus occupy respective stable positions, a raised or closed position during the molding of the component and the other one a lowered or open position during its demolding.

2. The jig for manufacturing components of aerodynes and wind turbines completely according to claim 1, characterized in that the elastic hinge (8) is preferably formed by an elastomer (8.1), such as a silicone, on which the parts forming the flanges (7) are locked or integrated.

3. The jig for manufacturing components of aerodynes and wind turbines completely according to claims 1, characterized in that, according to a preferred embodiment, the flanges (7) are arranged according to respective correlations of the two larger sides of the base (10).

4. The jig for manufacturing of components of aerodynes and wind turbines completely according to claim 1, characterized in that the flanges (7) of each side of the base (10) are identical to one another.

5. The jig for manufacturing components of aerodynes and wind turbines completely according to claim 1, characterized in that the flanges (7) of each side of the base (10) are, at least in one of them, different from one another.

6. The jig for manufacturing components of aerodynes and wind turbines completely according to claims 1, characterized in that each flange (7) is formed by a rigid single part, locked or integrated in the elastomer (8.1) forming the elastic hinge (8).

7. The jig for manufacturing components of aerodynes and wind turbines completely according to claims 1, characterized in that each flange (7) is formed by the association of an assembly of rigid parts locked or integrated in the elastomer (8.1) forming the elastic hinge (8).

8. A manufacturing process for components of aerodynes and wind turbines, of the type of process according to which, an assembly of fiber strips is placed manually or automatically on the upper part of a base, with the orientation and the thickness suitable for the stresses that the component to be manufactured must withstand, to subsequently inject resin and cure or polymerize the component which is finally demolded; characterized in that the fiber strips (11) are arranged on a base (10) provided on at least one of its sides with one or several flanges (7) with elastic hinges (8), with the flanges (7) arranged in a stable lowered or open position, to then perform a vacuum for compacting the fiber strips (11) and inject the corresponding resin; in that in a subsequent phase the flanges (7) are raised to a stable closed position to define between them and the base (10) the configuration of the component to be molded and once the process for curing this component has been carried out, the flanges (7) are again moved, by means of their elastic hinges (8), to the initial lowered or open position, in order to demold said component.

9. The manufacturing process for components of aerodynes and wind turbines completely according to claim 8, characterized in that, once the corresponding fiber strips (11) have been arranged on the base (10) and on the area of the flanges (7), until reaching all the precise layers (11.1), a plastic blanket (13) provided in its contour with a self-adhesive (12) is placed on these layers (11.1), by means of which self-adhesive the plastic blanket (13) is fixed on the base (10) and on the area of the flanges (7) to subsequently generate a vacuum for compacting the fiber strips (11) and subsequently inject resin; this vacuum and the injection of the resin can be carried out as a result of the tightness provided by the elastic hinges (8) of the flanges (7).
